(19) United States
(12) Patent Application Publication
(10) Pub. No.: US 2024/0277012 A1
(43) Pub. Date: Aug. 22, 2024

(54) DUPLICATE BEVERAGE

(71) Applicant: Jie Wang, Ann Arbor, MI (US)

(72) Inventor: Jie Wang, Ann Arbor, MI (US)

(21) Appl. No.: 18/218,121

(22) Filed: Jul. 5, 2023

Related U.S. Application Data
(60) Provisional application No. 63/359,117, filed on Jul. 7, 2022.

(51) Int. Cl. A23L 2/68; A23L 2/58; A23L 2/60

(52) U.S. Cl. CPC A23L 2/68; A23L 2/58; A23L 2/60

(57) ABSTRACT

Aspects of the present disclosure are directed to duplicate or synthetic beverages that exhibit the same (or substantially similar such that a consumer is unable to perceive a difference) aroma, taste, mouthfeel, and overall experience of traditional beverages. As used herein, “traditional beverages” generally refer to beverages that include natural beverages that are fresh (e.g., not-from-concentrate) or from-concentrate, while “duplicate beverages” generally refer to beverages that are simulated and are therefore not fresh and/or not-from-concentrate.

### PRIORITY INFORMATION

This application claims the benefit of U.S. Provisional Application No. 63/359,117, filed Jul. 7, 2022, the contents of which are considered to be part of this application and are incorporated herein by reference.

### TECHNICAL FIELD

Embodiments described herein relate generally to duplicate or “synthetic” beverages and more particularly to duplicate juice beverages with similar flavor and olfactory characteristics as natural beverages.

### BACKGROUND

Despite the nutritional benefits of natural juices, high production costs and limited resources can often drive up their prices, making them less accessible for some members of the global population. Although there are cheaper substitutes to 100% natural juices in the market, they do not provide similar flavor and olfactory characteristics as natural juices. The term “similar” is understood to also include “identical.” Thus, there exists a need for a duplicate beverage that is substantially free of natural juice but has similar flavor and olfactory characteristics.

### BRIEF DESCRIPTION OF THE DRAWINGS

FIG. 1 is a diagram illustrating an example duplicate beverage composition in accordance with a number of embodiments of the disclosure.

FIG. 2 is a diagram illustrating an example duplicate beverage composition in accordance with a number of embodiments of the disclosure.

FIG. 3 is a flow diagram corresponding to a method for making a duplicate beverage composition in accordance with a number of embodiments of the disclosure.

### DETAILED DESCRIPTION

Aspects of the present disclosure are directed to duplicate or “synthetic” beverages that exhibit the same (or substantially similar such that a consumer is unable to perceive a difference) aroma, taste, mouthfeel, and overall experience of traditional beverages. As used herein, “traditional beverages” generally refer to beverages that include natural beverages that are fresh (e.g., not-from-concentrate) or from-concentrate, while “duplicate beverages” or “synthetic beverages” generally refer to beverages that are simulated and are therefore not fresh and/or not-from-concentrate. An example of a“traditional beverage” is a fruit juice that contains greater than 10 percentage of natural juice based on a total weight percentage of the traditional beverage.

Non-limiting examples of duplicate beverages contemplated by the disclosure include synthetic fruit juices, such as orange juice, apple juice, grape juice, pineapple juice, cranberry juice, etc. For purposes of illustration, it is noted that examples described herein generally relate to a duplicate orange juice beverage; however, it will be appreciated that the non-limiting duplicate fruit juice examples (as well as others) mentioned above are contemplated within the scope of the disclosure. Further, it is noted that the terms “duplicate” and “synthetic,” particularly with respect the beverages described herein, may be used interchangeably. However, it will be appreciated that the terms “duplicate beverage” and “synthetic beverage” generally refer to beverages that contain less than a minimal threshold amount of the fruit and/or vegetable from which the beverage would traditionally be derived.

Accordingly, in a non-limiting example, a duplicate beverage may be a duplicate or synthetic orange juice that is neither made from fresh oranges nor from orange juice concentrate. Continuing with this non-limiting illustrative example in which the duplicate beverage is a simulated orange juice (and bearing in mind that other types and/or flavors of synthetic beverages are contemplated within the disclosure), the aroma, taste, mouthfeel, and overall experience of commonly used orange species in traditional orange juices such as Citrus sinensis, Citrus tangerina, and/or Citrus reticulata, among others can be simulated or otherwise replicated.

Many benefits can be realized from the duplicate beverages described herein. One such benefit can include manufacturing and/or logistical benefits. For example, the decoupling of orange juice production from a single crop and the overall reduction in production costs (e.g., raw material, transportation, and storage costs). Traditional orange juice production methods rely on the farming of a single crop—oranges—which is at the mercy of the weather and (lack of) crop disease. Devastating bacterial diseases have shaped and changed citrus production in many countries. Hurricanes in Florida, USA have caused at least 40% reduction in orange juice production due to flooding of orchards and early fruit dropping. According to USDA, orange juice is the most popular and in-demand “fruit juice” in the United States; however, the price of orange juice has risen over the years due to its short and uncertain supply.

In order to address the uncertain nature of orange crop production, embodiments herein allow for a duplicate beverage that replicates the aroma, taste, mouthfeel, and overall experience of orange juice (among other juices) consumption through the use of compounds and ingredients found in other crops to create the same flavor and aroma of traditional orange juice. This eliminates the reliance on a single-crop to create orange juice. For example, by utilizing ingredients from other higher-yielding and more resistant crops and fruits, embodiments described herein allow for the creation of a duplicate beverage that yields the same benefits and experience of consuming a traditional beverage. Further, by removing real oranges (and/or other fruits) embodiments herein allow for the reduction or elimination of the farming, concentrating, and storage of oranges and/or fruits. This can result in economic benefits thereby resulting in a lower cost of production and therefore a lower cost of goods, such as a duplicate orange juice beverage. Moreover, the duplicate beverages contemplated herein can be produced in less than 24 hours from raw materials to finished goods, thereby reducing over-production associated with traditional beverages.

Another benefit of the duplicate beverages described herein is the ability control every ingredient in such duplicate beverages. For example, traditional beverages (e.g., traditional orange juice) processes can involve various treatments to prolong the shelf life of such beverages, which can negatively affect aroma, flavor, and/or nutrition levels of the traditional beverages. In contrast, the duplicate beverages disclosed herein can allow for, for example, orange juice to be replicated while omitting toxic chemicals (e.g., pesticides, preservatives, etc.). Further, in the duplicate beverages described herein, sugar levels and nutritional content can be controlled with a greater level of precision than in traditional beverages. This flexibility and level of control over the content of the duplicate beverages described herein can provide a competitive advantage as general trends of healthier eating and lifestyle continue to become commonplace.

Another benefit includes various environmental benefits that may be realized through adoption of the duplicate beverages described herein. For example, the duplicate beverages described herein may require less water, less agricultural land use, and/or less processing waste than traditional beverages. According to ourworldindata.org, half of the world's habitable land is used for agriculture and agriculture is a threat for 86% of species extinction. The use of pesticides and fertilizers can result in the degradation of soil and leach into waterways and lagoons. Water shortage is also a well-known issue around the world. To combat some of these issues, water is recycled and reused in orange production in the United States and producers are required to install and use drip irrigation. Despite that, Southern California, for example, has still had to reduce production of oranges due to water shortages. In contrast, the duplicate beverages described herein can source ingredients from less fastidious and more efficient crops and generate far less water waste and processing waste in comparison to, for example, traditional orange juice. Further, the duplicate beverages described herein can be produced “on demand” (as mentioned above) thereby reducing over-production issues that can arise in traditional beverage manufacturing processes. Further, because the duplicate beverages described herein may not require fresh produce or fruits (e.g., fresh oranges), they can be created in any location globally, all year round.

Aspects of the present disclosure are directed to a duplicate and/or synthetic beverage (e.g., a juice that is not made from fresh ingredients and/or is not made from a concentrated juice mixture). However, as mentioned above, the duplicate beverages of the present disclosure exhibit the same (or substantially similar such that a consumer is unable to perceive a difference) aroma, taste, mouthfeel, and overall experience of traditional beverages (e.g., as juice that is made from fresh ingredients, such as a squeezed or pressed juice, or that is made from a concentrated juice mixture.

In some embodiments, the duplicate beverage composition includes these major component groups: acids, sweeteners, colorants, water, and volatile organic compounds. Acids can include one or more of tartaric acid, malic acid, citric acid, and/or ascorbic acid. Sweeteners can include one or more of sucrose, fructose, glucose, maltose, maltodextrin, and/or glycerin. Colorants can include one or more of beta-carotene, caramel, and/or vegetable- and plant-based colorants. Volatile organic compounds can include one or more of: esters, aldehydes, ketones, terpenes, alcohols, acids, pyrazines, and other volatile organic compounds (e.g., furfurals, phenols, lactones, sulfur-containing compounds, furans, amines, etc.). Additionally, the duplicate beverages of the present disclosure may include salts, amino acids, thickeners, and/or vitamins.

In some embodiments, the ingredients used in the duplicate beverages described herein are added in no particular order and mixed and/or recirculated for at least 10-15 minutes before being bottled or canned. Embodiments are not so limited, however, and in some embodiments, the ingredients used in the duplicate beverages described herein are added in a specified, particular order to facilitate creation of the duplicate beverage. In such embodiments, the ingredients may be mixed and/or recirculated for at least 10-15 minutes subsequent to being added in the specified, particular order prior to being bottled or canned. The bottled or canned product may not need to be pasteurized. Table 1 shows an example formula for a duplicate beverage in accordance with embodiments of the present disclosure.

TABLE 1

| Component | Percent by Weight (% w/w) |
|---|---|
| Malic acid | 0.01-0.10 |
| Citric acid | 0.05-1.0 |
| Ascorbic Acid | 0.0005-0.10 |
| Fructose | 1.0-20 |
| Glycerin | 1.0-5.0 |
| Water | 70-98 |
| Volatile Organic Compounds | 0.0005-1.0 |

The duplicate beverage composition can include between 0.01 to 0.10 percentage by weight of Malic Acid based on a total weight percentage of the duplicate beverage composition.

The duplicate beverage composition can include between 0.05-1.0 percentage by weight of Citric Acid based on a total weight percentage of the duplicate beverage composition.

The duplicate beverage composition can include between 0.0005-0.10 percentage by weight of Ascorbic Acid based on a total weight percentage of the duplicate beverage composition.

The duplicate beverage composition can include between 1.0-20 percentage by weight of Fructose based on a total weight percentage of the duplicate beverage composition.

The duplicate beverage composition can include between 1.0-5.0 percentage by weight of Glycerin based on a total weight percentage of the duplicate beverage composition.

The duplicate beverage composition can include between 70-98 percentage by weight of Water based on a total weight percentage of the duplicate beverage composition.

The duplicate beverage composition can include between 0.0005-1.0 percentage by weight of Volatile Organic Compounds based on a total weight percentage of the duplicate beverage composition.

The duplicate beverage composition can be substantially free from natural juice. For example, the duplicate beverage composition can include at or around 0.0 percentage by weight of natural juice based on a total weight percentage of the duplicate beverage composition. Embodiments are not so limited, however, and the duplicate beverage composition being substantially free from natural juice can include embodiments in which the duplicate beverage composition includes a negligible amount of natural juice (e.g., a fraction of a percentage by weight of natural juice based on a total weight percentage of the duplicate beverage composition that is less than 1.0 percentage by weight of natural juice based on a total weight percentage of the duplicate beverage composition).

Table 2 shows an example formula for a duplicate beverage in accordance with embodiments of the present disclosure. The ingredients shown in Table 2 can be used, in whole or in part, in connection with the ingredient shown in Table 1 in accordance with the disclosure. That is, the ingredients shown in Table 1 can be used in whole or in part with the ingredients shown in Table 2 to create the duplicate beverage, or vice versa. In addition to, or in the alternative, any of the ingredients described herein can be used in whole or in part to create the duplicate beverages contemplated by the disclosure. Similarly, any of the ingredients described herein can be mixed together in various combinations and/or in various processes to create the duplicate beverages contemplated by the disclosure. Various ingredients that may not be explicitly listed in the Tables herein can be included in the duplicate beverages described herein. Non-limiting examples of such ingredients can include, but are not limited to Fructose, Dextrose, Malic Acid, Glycerin, Vitamin compounds (e.g., Vitamin A compounds, Vitamin B compounds, Vitamin C compounds, Vitamin D compounds, etc.). In addition to or in the alternative, small amounts of alcohol may be added to the duplicate beverages herein. These ingredients can be provided in varying combinations or sub-combinations and/or in varying amounts (whether by weight, volume, percentage, or any other similar metric). Such ingredients may be provided in the duplicate beverages described herein to alter and/or enhance the flavor of the duplicate beverage and/or may be provided to supplement the duplicate beverages with various nutrients that may be beneficial to consumers of the duplicate beverages described herein.

In addition, various ingredients that may not be explicitly listed in Tables herein can be included in the duplicate beverages described herein to alter and/or enhance the color of the duplicate beverages described herein. For example, various plants, roots, leaves, vegetables, fruits, and/or other naturally substances that can alter and/or enhance the color of the duplicate beverages of the present disclosure can be provided in the duplicate beverages described here. In some embodiments, such plants, roots, leaves, vegetables, fruits, and/or other naturally substances can be included in the duplicate beverages to provide a color that is consistent with a natural beverages or juices that the duplicate beverages described herein replicate.

Further, various ingredients that may not be explicitly listed in Tables herein can be included in the duplicate beverages described herein to alter and/or enhance the flavor of the duplicate beverages described herein. For example, various plants, roots, leaves, vegetables, fruits, and/or other naturally substances that can alter and/or enhance the flavor of the duplicate beverages of the present disclosure can be provided in the duplicate beverages described here. In some embodiments, such plants, roots, leaves, vegetables, fruits, and/or other naturally substances can be included in the duplicate beverages to provide a flavor that is consistent with a natural beverages or juices that the duplicate beverages described herein replicate.

Tables 2 and 3, below are used to illustrate a non-limiting example of a recipe and process for making the duplicate beverages described herein. The example described in connection with Table 2 and Table 3 yields approximately 500 mL of the duplicate beverage described herein. Table 2 includes ingredients that can form a base (e.g., a juice base) of the duplicate beverages described herein while Table 3 includes ingredients that form a flavor base of the duplicate beverages described herein. The ingredients of Table 2 and Table 3 can be added in any order.

In some embodiments, the ingredients listed in Table 2 and/or the ingredients listed in Table 3 can be mixed together in various mixing vessels (e.g., mixing glasses, tanks, dewars, etc.). During mixing and/or processing, the ingredients may be kept at room temperature, or the ingredients may be heated, or the ingredients may be cooled for one or more processes or for varying times during processing the duplicate beverage.

TABLE 2

| Ingredient | Percent by Weight (% w/w)* |
|---|---|
| Malic acid | 0.01-0.10 |
| Citric acid | 0.05-1.0 |
| Ascorbic Acid | 0.0005-0.10 |
| Fructose | 1.0-20 |
| Glycerin | 1.0-5.0 |
| Water | 70-98 |

As mentioned above, Table 2 shows ingredients that can form a base (e.g., a juice base) for the duplicate beverages described herein. The percentage by weights shown in Table 3 are indicate of a total weight percentage of the ingredients shown in Table 3 for the finished duplicate beverage. A non-limiting example of a recipe for a duplicate juice in accordance with the disclosure is provided below:
Add 300 mL of water in a mixing glass.
Add and mix 0.25 grams of malic acid.
Add and mix 2.5 grams of citric acid.
Add and mix 0.1 grams of ascorbic acid.
Add and mix 50 grams of fructose.
Add and mix 12.5 grams of glycerin.
Natural coloring material may be added.

Table 3 shows ingredients that can form a flavor base for the duplicate beverages described herein. The flavor base is created with a mixture of volatile organic compounds. The flavor base (aka the volatile organic compounds) may make up between 0.0005-1.0 percent by weight (% w/w) of the final duplicate beverage/juice. An example recipe for the flavor base is below, where the volatile organic compounds are added in no particular order.

TABLE 3

| Volatile Organic Compound | Use Rate (mg/L) |
|---|---|
| Acetone | 2.5 |
| Ethyl Acetate | 33.5 |
| Butanoic acid, 2-methyl-, ethyl ester | 11.5 |
| Camphene | 45 |
| Myrcene (e.g., β-Myrcene) | 0.11 |
| Pinene (e.g., α-Pinene) | 2.7 |
| Phellandrene (e.g., α-Phellandrene) | 6.5 |
| Pinene (e.g., β-Pinene) | 0.21 |
| Terpinene (e.g., α-Terpinene) | 6 |
| Limonene | 99 |
| Terpinene (e.g., γ-Terpinene) | 0.085 |
| Terpinolene | 0.16 |
| Linalool | 0.35 |
| Citral | 14 |
| Geraniol | 2.5 |
| Total (mg per Liter) | 224 |

In some embodiments, the duplicate beverages described herein are created by mixing the flavor base of Table 3 with the base (e.g., the juice base) of Table 2. In the example shown in connection with Table 2 and table 3, 112 milligrams (Total 224 mg per liter times 0.5 liters) of the flavor base is added to the existing base. The end mixture is then topped up to 500 mL with more water or other liquid(s).

One or more of the ingredients shown in Tables 2 and 3 can provide visual, flavor, and/or olfactory characteristics to the duplicate beverage described herein. For example, one or more of the ingredients of Tables 2 and 3 can provide a color to the duplicate beverage described herein, an aroma to the duplicate beverage described herein, and/or a flavor to the duplicate beverage described herein.

Various ingredients that may not be explicitly listed in Tables 1, 2, and 3 can be included in the duplicate beverages described herein. Non-limiting examples of such ingredients can include, but are not limited to Fructose, Dextrose, Malic Acid, Glycerin, Vitamin compounds (e.g., Vitamin A compounds, Vitamin B compounds, Vitamin C compounds, Vitamin D compounds, etc.). These ingredients can be provided in varying combinations or sub-combinations and/or in varying amounts (whether by weight, volume, percentage, or any other similar metric). Such ingredients may be provided in the duplicate beverages described herein to alter and/or enhance the flavor of the duplicate beverage and/or may be provided to supplement the duplicate beverages with various nutrients that may be beneficial to consumers of the duplicate beverages described herein.

In addition, various ingredients that may not be explicitly listed in Tables 1, 2 and 3 can be included in the duplicate beverages described herein to alter and/or enhance the color of the duplicate beverages described herein. For example, various plants, roots, leaves, vegetables, fruits, and/or other naturally substances that can alter and/or enhance the color of the duplicate beverages of the present disclosure can be provided in the duplicate beverages described here. In some embodiments, such plants, roots, leaves, vegetables, fruits, and/or other naturally substances can be included in the duplicate beverages to provide a color that is consistent with a natural beverages or juices that the duplicate beverages described herein replicate.

Further, various ingredients that may not be explicitly listed in Tables 1, 2, and 3 can be included in the duplicate beverages described herein to alter and/or enhance the flavor of the duplicate beverages described herein. For example, various plants, roots, leaves, vegetables, fruits, and/or other naturally substances that can alter and/or enhance the flavor of the duplicate beverages of the present disclosure can be provided in the duplicate beverages described here. In some embodiments, such plants, roots, leaves, vegetables, fruits, and/or other naturally substances can be included in the duplicate beverages to provide a flavor that is consistent with a natural beverages or juices that the duplicate beverages described herein replicate.

The following Tables show various non-limiting example major volatile organic compounds that may be used as ingredients in the duplicate beverages described herein. Embodiments contemplate that one or more volatile organic compounds in each major volatile organic compound category, which generally includes these categories: aldehydes, acids, alcohols, esters, ketones, pyrazines, terpenes, and other volatile organic compounds, may be used as ingredients for the duplicate beverages described herein. For example, Table 4 lists examples of aldehydes that may be used as ingredients in the duplicate beverages described herein.

TABLE 4
ALDEHYDES

ACETAL
ACETALDEHYDE
PROPYL PHENETHYL ACETAL
ALPHA-AMYLCINNAMALDEHYDE
BENZALDEHYDE
BENZALDEHYDE DIMETHYL ACETAL
BENZALDEHYDE GLYCERYL ACETAL
BENZALDEHYDE PROPYLENE GLYCOL ACETAL
BUTYRALDEHYDE
ISOBUTYRALDEHYDE
CINNAMALDEHYDE
CINNAMALDEHYDE ETHYLENE GLYCOL ACETAL
CITRAL
CITRAL DIETHYL ACETAL
CITRAL DIMETHYL ACETAL
CITRONELLAL
CITRONELLOXYACETALDEHYDE
CUMINALDEHYDE
DECANAL DIMETHYL ACETAL
2-DECENAL
2-DODECENAL
FURFURAL
HEPTANAL
HEXANAL
HEXEN-2-AL
CIS-3-HEXENAL
HYDROXYCITRONELLAL
HYDROXYCITRONELLAL DIETHYL ACETAL
LAURIC ALDEHYDE
P-METHOXYBENZALDEHYDE
2-METHYLBUTYRALDEHYDE
ALPHA-METHYLCINNAMALDEHYDE
3-(METHYLTHIO)PROPIONALDEHYDE
2-METHYLUNDECANAL
NONANAL
OCTANAL
OCTANAL DIMETHYL ACETAL
PHENYLACETALDEHYDE
PHENYLACETALDEHYDE DIMETHYL ACETAL
PHENYLACETALDEHYDE GLYCERYL ACETAL
2-PHENYLPROPIONALDEHYDE
3-PHENYLPROPIONALDEHYDE
2-PHENYLPROPIONALDEHYDE DIMETHYL ACETAL
PIPERONAL
PROPIONALDEHYDE
3-(P-ISOPROPYLPHENYL)PROPIONALDEHYDE
SALICYLALDEHYDE
P-TOLYLACETALDEHYDE
2-(P-TOLYL)PROPIONALDEHYDE
UNDECANAL
VALERALDEHYDE
VERATRALDEHYDE
2-BENZOFURANCARBOXALDEHYDE
2-TRANS,4-TRANS-DECADIENAL
2,6-DIMETHYL-10-METHYLENE-2,6,11-DODECATRIENAL
P-MENTH-1-ENE-9-AL
O-METHOXYCINNAMALDEHYDE
P-METHOXY-ALPHA-METHYLCINNAMALDEHYDE
5-METHYL-2-PHENYL-2-HEXENAL
2,4-PENTADIENAL
2-PENTENAL
4-HEPTENAL
3-(5-METHYL-2-FURYL)-BUTANAL
3-PHENYL-4-PENTENAL
PHENYLACETALDEHYDE DIISOBUTYL ACETAL
2-BUTYL-2-BUTENAL
2-ISOPROPYL-5-METHYL-2-HEXENAL
2-METHYLPENTANAL
TRANS,TRANS-2,4-HEXADIENAL
4-METHYL-2-PENTENAL
3,5,5-TRIMETHYLHEXANAL
P-MENTHA-1,8-DIEN-7-AL
CIS-6-NONENAL
(2,2,3-TRIMETHYLCYCLOPENT-3-EN-1-
YL)ACETALDEHYDE
CIS-5-OCTENAL
4-ETHYLBENZALDEHYDE
ETHYL VANILLIN PROPYLENE GLYCOL ACETAL
3-METHYLTHIOHEXANAL
VANILLIN 3-(L -MENTHOXY)PROPANE-1,2-DIOL ACETAL
VANILLIN PROPYLENE GLYCOL ACETAL
3-HEXENAL
4-HYDROXYBENZALDEHYDE
PARALDEHYDE
3,7,11-TRIMETHYL-2,6,10-DODECATRIENAL
VANILLIN ERYTHRO AND THREO-BUTAN-2,3-DIOL
ACETAL
ACETALDEHYDE DIISOAMYL ACETAL
(Z)-4-DODECENAL
4,5-EPOXY-(E)-2-DECENAL
(+/−)-2-(5-METHYL-5-VINYL-TETRAHYDROFURAN-2-
YL)PROPIONALDEHYDE
(Z)-8-TETRADECENAL
O-ANISALDEHYDE
(+/−)-TRANS- AND CIS-5-(2,2-DIMETHYLCYCLOPROPYL)-
3-METHYL-2-PENTENAL
(+/−)-3-(METHYLTHIO)HEPTANAL
3-METHYLHEXANAL
TRANS-4-NONENAL
(+/−)-CIS- AND TRANS-1,2-DIHYDROPERILLALDEHYDE
1-ETHYL-2-PYRROLECARBOXALDEHYDE
1-METHYL-1H-PYRROLE-2-CARBOXALDEHYDE
DODECANAL DIMETHYL ACETAL
HEPTANAL PROPYLENEGLYCOL ACETAL
ISOVALERALDEHYDE DIETHYL ACETAL
ACETALDEHYDE 1,3-OCTANEDIOL ACETAL
HEXANAL OCTANE-1,3-DIOL ACETAL
HEXANAL BUTANE-2,3-DIOL ACETAL
(+/−)-CIS- AND TRANS-2-METHYL-2-(4-METHYL-3-
PENTENYL)CYCLOPROPANECARBALDEHYDE
2-NONANONE PROPYLENEGLYCOL ACETAL
6-METHYL-5-HEPTEN-2-ONE PROPYLENEGLYCOL
ACETAL
(+/−)-ACETALDEHYDE ETHYL ISOPROPYL ACETAL
(+/−)-6-METHYLOCTANAL
2-HYDROXY-4-METHOXYBENZALDEHYDE
Hydroxycitronellal propyleneglycol acetal
CITRAL GLYCERYL ACETAL
6-METHYLHEPTANAL
3-[(2-METHYL-3-FURYL)THIO]BUTANAL
1,3-P-MENTHADIEN-7-AL
ACETALDEHYDE DI-ISOBUTYLACETAL
ACETALDEHYDE ETHYL ISOBUTYL ACETAL
3-MERCAPTOHEXANAL
2,3-EPOXYOCTANAL
2,3-EPOXYDECANAL
(E)-4-UNDECENAL
(+)-6-METHOXY-2,6-DIMETHYLHEPTANAL
2,6,10-TRIMETHYL-9-UNDECENAL
Mixture of 1-Vinyl-3-cyclohexenecarbaldehyde and 4-Vinyl-1-
cyclohexenecarbaldehyde
2-Octyl-2-dodecenal
2-Hexyl-2-decenal
trans-6-Octenal
3-(Acetylthio)hexanal
(+/−)-8-Methyldecanal
8-Methylnonanal
2,6-Dipropyl-5,6-dihydro-2H-thiopyran-3- carboxaldehyde
E-6-Nonenal
Mixture of 3- and 4-butyl-2-thiophenecarboxyaldehyde

Table 5 lists examples of acids that may be used as ingredients in the duplicate beverages described herein.

TABLE 5
ACIDS

ACETIC ACID
ACONITIC ACID
ADIPIC ACID
ASCORBIC ACID
BENZOIC ACID
BUTYRIC ACID
CINNAMIC ACID
CITRIC ACID
FORMIC ACID
FUMARIC ACID
LACTIC ACID
LEVULINIC ACID
2-METHYLBUTYRIC ACID
NONANOIC ACID
PHENOXYACETIC ACID
PHENYLACETIC ACID
3-PHENYLPROPIONIC ACID
PROPIONIC ACID
PYROLIGNEOUS ACID
PYRUVIC ACID
VALERIC ACID
ISOVALERIC ACID
TRANS-2-HEXENOIC ACID
3-HEXENOIC ACID
2-MERCAPTOPROPIONIC ACID
2-METHYL-2-PENTENOIC ACID
10-UNDECENOIC ACID
L-GLUTAMIC ACID
4-HYDROXYBUTANOIC ACID LACTONE
9,12-OCTADECADIENOIC ACID (48%) AND 9,12,15-
OCTADECATRIENOIC ACID (52%)
4-METHYLPENTANOIC ACID
2-METHYL-4-PENTENOIC ACID
5-HYDROXY-7-DECENOIC ACID DELTA-LACTONE
5-HYDROXY-8-UNDECENOIC ACID DELTA-LACTONE
2,4-DIHYDROXYBENZOIC ACID
5-HYDROXY-2-DODECENOIC ACID LACTONE
4-HYDROXY-3-METHYLOCTANOIC ACID LACTONE
2-(4-METHYL-2-HYDROXYPHENYL)PROPIONIC ACID-GAMMA-
LACTONE
3-METHYL-2-OXOBUTANOIC ACID
3-METHYL-2-OXOPENTANOIC ACID
4-METHYL-2-OXOPENTANOIC ACID
2-DECENOIC ACID
2,4-HEXADIENOIC ACID, (E,E)-
2-METHOXYBENZOIC ACID
3-METHOXYBENZOIC ACID
2-HYDROXYBENZOIC ACID
4-HYDROXYBENZOIC ACID
4-HYDROXY-3-METHOXYBENZOIC ACID
(+/−)-(2,6,6-TRIMETHYL-2-
HYDROXYCYCLOHEXYLIDENE)ACETIC ACID GAMMA-
LACTONE
4-HYDROXY-2,3-DIMETHYL-2,4-NONADIENOIC ACID GAMMA
LACTONE
4-HYDROXY-4-METHYL-5-HEXENOIC ACID GAMMA
LACTONE
N-BENZOYLANTHRANILIC ACID
CIS-AND TRANS-2-HEPTYLCYCLOPROPANECARBOXYLIC
ACID
4-HYDROXY-2-BUTENOIC ACID GAMMA-LACTONE
2-(2-HYDROXY-4-METHYL-3-CYCLOHEXENYL)PROPIONIC
ACID GAMMA-LACTONE
5-HYDROXY-4-METHYLHEXANOIC ACID DELTA-LACTONE
2-NONENOIC ACID GAMMA-LACTONE
POLYGLYCEROL ESTERS OF FATTY ACIDS
THIOACETIC ACID
2-(2-HYDROXYPHENYL) CYCLOPROPANECARBOXYLIC ACID
DELTA LACTONE
4-AMINOBUTYRIC ACID,
N-[2-(3,4-DIMETHOXYPHENYL)ETHYL]-3,4-
DIMETHOXYCINNAMIC ACID AMIDE
CIS-3-HEXENOIC ACID
HYDROXY(4-HYDROXY-3-METHOXYPHENYL)ACETIC ACID
O-TRANS-COUMARIC ACID
SUCCINIC ACID
GLUTAMYL-2-AMINOBUTYRIC ACID
3-[3-(2-ISOPROPYL-5-METHYLCYCLOHEXYL)-UREIDO]-
BUTYRIC ACID ETHYL ESTER
4-AMINO-5-(3-(ISOPROPYLAMINO)-2,2-DIMETHYL-3-
OXOPROPOXY)-2-METHYLQUINOLINE-3-CARBOXYLIC ACID
(+/−)-Bicyclo[2.2.1]hept-5-ene-2-carboxylic acid, ethyl ester
hexanoic acid
octanoic acid

Table 6 lists examples of alcohols that may be used as ingredients in the duplicate beverages described herein.

TABLE 6
ALCOHOLS

AMYL ALCOHOL
ISOAMYL ALCOHOL
ALPHA-AMYLCINNAMYL ALCOHOL
ANISYL ALCOHOL
BENZYL ALCOHOL
BUTYL ALCOHOL
ISOBUTYL ALCOHOL
ALPHA-ISOBUTYLPHENETHYL ALCOHOL
CARVACROL
CINNAMYL ALCOHOL
DL-CITRONELLOL
P-CRESOL
1-DECANOL
ETHYL ALCOHOL
4-ETHYLGUAIACOL
EUCALYPTOL
EUGENOL
ISOEUGENOL
FARNESOL
FURFURYL ALCOHOL
GERANIOL
GLYCEROL
GUAIACOL
HEXYL ALCOHOL
HYDROXYCITRONELLOL
(+)-NEOISOMENTHOL
2-METHOXY-4-METHYLPHENOL
2,6-NONADIEN-1-OL
1-OCTEN-3-OL
PHENETHYL ALCOHOL
1-PHENYL-3-METHYL-3-PENTANOL
3-PHENYL-1-PROPANOL
PROPENYLGUAETHOL
PROPYL ALCOHOL
ISOPROPYL ALCOHOL
P-ISOPROPYLBENZYL ALCOHOL
PROPYLENE GLYCOL
ISOPULEGOL
RHODINOL
D-SORBITOL
ALPHA-TERPINEOL
TETRAHYDROFURFURYL ALCOHOL
THYMOL
UNDECYL ALCOHOL
P-ETHYLPHENOL
P-MENTH-1-EN-3-OL
2-METHYL-3-FURANTHIOL
PHENOL
4-THUJANOL
2-HEPTANOL
4-HEXEN-1-OL
CIS-6-NONEN-1-OL
CIS-3-OCTEN-1-OL
PROPANETHIOL
3-HEPTANOL
P-MENTHAN-2-OL
P-MENTH-8-EN-1-OL
3-OCTANOL
1-PENTEN-3-OL
BENZENETHIOL
2,6-DIMETHYLTHIOPHENOL
1-P-MENTHENE-8-THIOL
3-METHYL-2-BUTANOL
CIS-5-OCTEN-1-OL
P-VINYLPHENOL
ALPHA-CAMPHOLENIC ALCOHOL
3-L-MENTHOXYPROPANE-1,2-DIOL
4-METHOXY-2-METHYL-2-BUTANETHIOL
2-PENTANETHIOL
1-DECEN-3-OL
(E,R)-3,7-DIMETHYL-1,5,7-OCTATRIEN-3-OL
(Z)-4-HEPTEN-1-OL
3-(L-MENTHOXY)-2-METHYLPROPANE-1,2-DIOL
3-MERCAPTOHEXANOL
(E)-3-(Z)-6-NONADIEN-1-OL
(Z)(Z)-3,6-NONADIEN-1-OL
(E)-2-OCTEN-4-OL
PRENYLTHIOL
2,3,4-TRIMETHYL-3-PENTANOL
2,4-DECADIEN-1-OL
2,4-HEXADIEN-1-OL
2,4-NONADIEN-1-OL
(E,E)-2,4-OCTADIEN-1-OL
2,3,6-TRIMETHYLPHENOL
1-AMINO-2-PROPANOL
CIS AND TRANS-2,5-DIMETHYLTETRAHYDROFURAN-3-THIOL
(+/−)-2-MERCAPTO-2-METHYLPENTAN-1-OL
(+/−) 2-METHYL-1-BUTANOL
(+/−)-DIHYDROFARNESOL
P-MENTHANE-3,8-DIOL
4-PROPENYLPHENOL
(+/−)-TRANS- AND CIS-4,8-DIMETHYL-3,7-NONADIEN-2-OL
ETHANE-1,1-DITHIOL
2-(L-MENTHOXY)ETHANOL
(+/−)-4-MERCAPTO-4-METHYL-2-PENTANOL
(S1)-METHOXY-3-HEPTANETHIOL
TRANS- AND CIS-2,4,8-TRIMETHYL-3,7-NONADIEN-2-OL
(+/−)-2,4,8-TRIMETHYL-7-NONEN-2-OL
(+/−)-3-(ETHYLTHIO)BUTANOL
2,4,6-TRIMETHYLPHENOL
CIS-4-DECENOL
CIS-4-OCTENOL
TRANS-3-HEXENOL
2,4-DIMETHYL-4-NONANOL
8-P-MENTHENE-1,2-DIOL
CARYOPHYLLENE ALCOHOL
D-2,8-P-MENTHADIEN-1-OL
CIS-3-NONEN-1-OL
(R)-(−)-1-OCTEN-3-OL
CUBEBOL
(−)-SCLAREOL
(+)-CEDROL
P-MENTH-1-EN-9-OL
2,2,6,7-TETRAMETHYLBICYCLO[4.3.0]NONA-4,9(1)-DIEN-8-OL
DODECANETHIOL
2-HYDROXYETHANETHIOL
2-PHENOXYETHANOL
4-METHYLBENZYL ALCOHOL
ALPHA-BISABOLOL
OCTAHYDRO-4,8A-DIMETHYL-4A(2H)-NAPHTHOL
2-[2-(P-MENTHYLOXY)ETHOXY]ETHANOL
TRANS-4-TERT-BUTYLCYCLOHEXANOL
DL-ISOMENTHOL
1,5-OCTADIEN-3-OL
(±)-2,5-UNDECADIEN-1-OL
1,3-PROPANEDIOL
(−)-MATAIRESINOL
3-METHYL-5-(2,2,3-TRIMETHYLCYCLOPENT-3-EN-1-YL)PENT-4-
EN-2-OL
(1-METHYL-2-(1,2,2-TRIMETHYLBICYCLO[3.1.0]HEX-3-
YLMETHYL)CYCLOPROPYL)METHANOL
Caryophylla-3(4),8-dien-5-ol
2(3)-Hexanethiol
2,6-Dimethyl-5-heptenol
(+/−)-3-Mercapto-1-pentanol
2-(5-Isopropyl-2-methyltetrahydrothiophen-2-yl)ethanol
10% solution of 3,4-dimethyl-2,3-dihydrothiophene-2-thiol

Table 7 lists examples of esters that may be used as ingredients in the duplicate beverages described herein.

TABLE 7
ESTERS

ALLYL ANTHRANILATE
ALLYL BUTYRATE
ALLYL CINNAMATE
ALLYL CYCLOHEXANEACETATE
ALLYL CYCLOHEXANEBUTYRATE
ALLYL CYCLOHEXANEHEXANOATE
ALLYL CYCLOHEXANEPROPIONATE
ALLYL CYCLOHEXANEVALERATE
ALLYL 2-ETHYLBUTYRATE
ALLYL 2-FUROATE
ALLYL HEPTANOATE
ALLYL HEXANOATE
ALLYL NONANOATE
ALLYL OCTANOATE
ALLYL PHENOXYACETATE
ALLYL PHENYLACETATE
ALLYL PROPIONATE
ALLYL 10-UNDECENOATE
ALLYL ISOVALERATE
ISOAMYL ACETATE
ISOAMYL BENZOATE
AMYL BUTYRATE
ISOAMYL BUTYRATE
ISOAMYL CINNAMATE
ALPHA-AMYLCINNAMYL ACETATE
ALPHA-AMYLCINNAMYL FORMATE
ALPHA-AMYLCINNAMYL ISOVALERATE
AMYL FORMATE
ISOAMYL FORMATE
ISOAMYL 4(2-FURAN)BUTYRATE
ISOAMYL 3(2-FURAN)PROPIONATE
AMYL 2-FUROATE
AMYL HEPTANOATE
AMYL HEXANOATE
ISOAMYL HEXANOATE
ISOAMYL NONANOATE
ISOAMYL OCTANOATE
ISOAMYL PHENYLACETATE
ISOAMYL PROPIONATE
ISOAMYL SALICYLATE
ISOAMYL ISOVALERATE
P-ANISYL ACETATE
ANISYL BUTYRATE
ANISYL FORMATE
ANISYL PROPIONATE
BENZYL ACETATE
BENZYL ACETOACETATE
BENZYL BENZOATE
BENZYL BUTYRATE
BENZYL ISOBUTYRATE
BENZYL CINNAMATE
BENZYL FORMATE
BENZYL PHENYLACETATE
BENZYL PROPIONATE
BENZYL ISOVALERATE
BUTYL ACETATE
ISOBUTYL ACETATE
BUTYL ANTHRANILATE
ISOBUTYL ANTHRANILATE
BUTYL BUTYRATE
ISOBUTYL BUTYRATE
BUTYL ISOBUTYRATE
ISOBUTYL ISOBUTYRATE
BUTYL BUTYRYLLACTATE
BUTYL CINNAMATE
ISOBUTYL CINNAMATE
BUTYL FORMATE
ISOBUTYL FORMATE
ISOBUTYL 3-(2-FURAN)PROPIONATE
BUTYL HEXANOATE
BUTYL PROPIONATE
ISOBUTYL PROPIONATE
BUTYL STEARATE
BUTYL 10-UNDECENOATE
CARVYL ACETATE
CINNAMYL ACETATE
CINNAMYL BUTYRATE
CINNAMYL ISOBUTYRATE
CINNAMYL CINNAMATE
CINNAMYL FORMATE
CINNAMYL PHENYLACETATE
CINNAMYL PROPIONATE
CINNAMYL ISOVALERATE
CITRONELLYL ACETATE
CITRONELLYL BUTYRATE
CITRONELLYL ISOBUTYRATE
CITRONELLYL FORMATE
CITRONELLYL PHENYLACETATE
CITRONELLYL PROPIONATE
CITRONELLYL VALERATE
CYCLOHEXYL ACETATE
CYCLOHEXYL ANTHRANILATE
CYCLOHEXYL BUTYRATE
CYCLOHEXYL CINNAMATE
CYCLOHEXYL FORMATE
CYCLOHEXYL PROPIONATE
CYCLOHEXYL ISOVALERATE
DECYL ACETATE
DIETHYL MALATE
DIETHYL MALONATE
DIETHYL SEBACATE
DIETHYL SUCCINATE
DIHYDROCARVYL ACETATE
ALPHA,ALPHA-DIMETHYLBENZYL ISOBUTYRATE
ALPHA,ALPHA-DIMETHYLPHENETHYL ACETATE
ALPHA,ALPHA-DIMETHYLPHENETHYL BUTYRATE
ETHYL ACETATE
ETHYL ACETOACETATE
ETHYL ACRYLATE
ETHYL ANTHRANILATE
ETHYL BENZOATE
ETHYL BUTYRATE
ETHYL ISOBUTYRATE
ETHYL CINNAMATE
ETHYL CYCLOHEXANEPROPIONATE
ETHYL DECANOATE
ETHYL FORMATE
ETHYL 3(2-FURYL)PROPANOATE
ETHYL HEPTANOATE
ETHYL HEXANOATE
ETHYL LACTATE
ETHYL LAURATE
ETHYL LEVULINATE
ETHYL 2-METHYLBUTYRATE
ETHYL METHYLPHENYLGLYCIDATE
ETHYL MYRISTATE
ETHYL NONANOATE
ETHYL 2-NONYNOATE
ETHYL OCTANOATE
ETHYL PHENYLACETATE
ETHYL PROPIONATE
ETHYL PYRUVATE
ETHYL SALICYLATE
ETHYL 10-UNDECENOATE
ETHYL VALERATE
ETHYL ISOVALERATE
GERANYL ACETATE
GERANYL BUTYRATE
GERANYL ISOBUTYRATE
GERANYL FORMATE
GERANYL HEXANOATE
GERANYL PHENYLACETATE
GERANYL PROPIONATE
GERANYL ISOVALERATE
HEPTYL ACETATE
HEXYL ACETATE
HEXYL BUTYRATE
HEXYL FORMATE
HEXYL 2-FUROATE
HEXYL HEXANOATE
HEXYL PROPIONATE
LINALYL ACETATE
LINALYL ANTHRANILATE
LINALYL BENZOATE
LINALYL BUTYRATE
LINALYL ISOBUTYRATE
LINALYL CINNAMATE
LINALYL FORMATE
LINALYL HEXANOATE
LINALYL OCTANOATE
LINALYL PROPIONATE
LINALYL ISOVALERATE
MENTHYL ISOVALERATE
METHYL ACETATE
METHYL ANTHRANILATE
METHYL BENZOATE
ALPHA-METHYLBENZYL ACETATE
ALPHA-METHYLBENZYL BUTYRATE
ALPHA-METHYLBENZYL ISOBUTYRATE
ALPHA-METHYLBENZYL FORMATE
ALPHA-METHYLBENZYL PROPIONATE
METHYL P-TERT-BUTYLPHENYLACETATE
METHYL BUTYRATE
METHYL ISOBUTYRATE
METHYL CINNAMATE
METHYL 2-FUROATE
METHYL HEPTANOATE
METHYL HEXANOATE
METHYL 2-HEXENOATE
METHYL O-METHOXYBENZOATE
METHYL N-METHYLANTHRANILATE
METHYL 2-METHYLBUTYRATE
METHYL 3-METHYLTHIOPROPIONATE
METHYL NONANOATE
METHYL 2-NONYNOATE
METHYL OCTANOATE
METHYL 2-OCTYNOATE
METHYL PHENYLACETATE
METHYL 3-PHENYLPROPIONATE
METHYL PROPIONATE
METHYL SALICYLATE
METHYL 2-UNDECYNOATE
METHYL ISOVALERATE
NERYL BUTYRATE
NERYL ISOBUTYRATE
NERYL PROPIONATE
NERYL ISOVALERATE
NONYL ACETATE
OCTYL ACETATE
OCTYL BUTYRATE
OCTYL ISOBUTYRATE
OCTYL FORMATE
OCTYL OCTANOATE
OCTYL PHENYLACETATE
PHENETHYL ACETATE
PHENYLETHYL ANTHRANILATE
PHENETHYL BENZOATE
PHENETHYL BUTYRATE
PHENETHYL ISOBUTYRATE
PHENETHYL CINNAMATE
PHENETHYL FORMATE
PHENETHYL PHENYLACETATE
PHENETHYL PROPIONATE
PHENETHYL SALICYLATE
PHENETHYL SENECIOATE
PHENETHYL TIGLATE
PHENETHYL ISOVALERATE
2-PHENOXYETHYL ISOBUTYRATE
4-PHENYL-2-BUTYL ACETATE
3-PHENYLPROPYL ACETATE
2-PHENYLPROPYL BUTYRATE
2-PHENYLPROPYL ISOBUTYRATE
3-PHENYLPROPYL ISOBUTYRATE
3-PHENYLPROPYL PROPIONATE
3-PHENYLPROPYL ISOVALERATE
PIPERONYL ACETATE
PIPERONYL ISOBUTYRATE
PROPYL ACETATE
ISOPROPYL ACETATE
PROPYL BUTYRATE
ISOPROPYL BUTYRATE
PROPYL ISOBUTYRATE
ISOPROPYL ISOBUTYRATE
PROPYL ISOVALERATE
ISOPROPYL ISOVALERATE
ISOPULEGYL ACETATE
RHODINYL ACETATE
RHODINYL BUTYRATE
RHODINYL ISOBUTYRATE
RHODINYL FORMATE
RHODINYL PHENYLACETATE
RHODINYL PROPIONATE
RHODINYL ISOVALERATE
SANTALYL ACETATE
SANTALYL PHENYLACETATE
SODIUM ACETATE
SODIUM BENZOATE
SODIUM CITRATE
BETA-TERPINYL ANTHRANILATE
TERPINYL BUTYRATE
TERPINYL ISOBUTYRATE
TERPINYL CINNAMATE
TERPINYL FORMATE
TERPINYL PROPIONATE
TERPINYL ISOVALERATE
TETRAHYDROFURFURYL ACETATE
TETRAHYDROFURFURYL BUTYRATE
TETRAHYDROFURFURYL PROPIONATE
O-TOLYL ACETATE
P-TOLYL ACETATE
P-TOLYL ISOBUTYRATE
P-TOLYL PHENYLACETATE
TRIETHYL CITRATE
VANILLIN ACETATE
ETHYL TRANS-2,CIS-4-DECADIENOATE
FURFURYL THIOACETATE
CIS-3-HEXEN-1-YL ACETATE
HEXYL ISOBUTYRATE
ALPHA-METHYLPHENETHYL BUTYRATE
ISOPROPYL TIGLATE
DISODIUM SUCCINATE
FURFURYL 3-METHYLBUTANOATE
METHYL 2-THIOFUROATE
TETRAHYDROFURFURYL CINNAMATE
BUTAN-3-ONE-2-YL BUTANOATE
3,7-DIMETHYLOCTA-2,6-DIENYL 2-ETHYLBUTANOATE
ETHYL 2-ETHYL-3-PHENYLPROPANOATE
1,3,3-TRIMETHYL-2-NORBORNANYL ACETATE
CIS-3-HEXENYL BUTYRATE
CIS-3-HEXENYL HEXANOATE
METHYL DIHYDROJASMONATE
ETHYL 2-METHYL-3-PENTENOATE
MALTYL ISOBUTYRATE
ETHYL TRANS-2-BUTENOATE
ETHYL 2-METHYL-4-PENTENOATE
ETHYL OCTADECANOATE
ETHYL UNDECANOATE
3-HEXENYL 2-METHYLBUTANOATE
3-HEXENYL 3-METHYLBUTANOATE
HEXYL 2-METHYLBUTANOATE
HEXYL ISOVALERATE
3-METHYLBUTYL 2-METHYLBUTANOATE
2-METHYLBUTYL 3-METHYLBUTANOATE
3-METHYLBUTYL 2-METHYLPROPANOATE
METHYL 3-HYDROXYHEXANOATE
TRANS-2-OCTEN-1-YL ACETATE
TRANS-2-OCTEN-1-YL BUTANOATE
ETHYL 3-HYDROXYHEXANOATE
ISOAMYL ACETOACETATE
P-MENTHA-1,8-DIEN-7-YL ACETATE
OCTYL 2-METHYLBUTYRATE
PHENYLETHYL 2-METHYLBUTYRATE
3-HEXENYL PHENYLACETATE
CAMPHOLENE ACETATE
ETHYL TRANS-2-HEXENOATE
ETHYL 3-METHYLPENTANOATE
ETHYL 4-(METHYLTHIO)BUTYRATE
ETHYL CIS-4,7-OCTADIENOATE
ETHYL 3-OXOHEXANOATE
CIS-3-HEXENYL BENZOATE
CIS-3-HEXENYL LACTATE
HEXYL BENZOATE
HEXYL TRANS-2-HEXENOATE
HEXYL 2-METHYL-3&4-PENTENOATE
METHYL 2-HYDROXY-4-METHYLPENTANOATE
METHYL 2-METHYLPENTANOATE
METHYL 2-METHYLTHIOBUTYRATE
METHYL NICOTINATE
METHYL TRANS-2-OCTENOATE
METHYL 2-OXO-3-METHYLPENTANOATE
METHYL SORBATE
ANISYL PHENYLACETATE
L-MENTHYL LACTATE
POTASSIUM 2-(1′-ETHOXY)ETHOXYPROPANOATE
ETHYL METHYL-P-TOLYLGLYCIDATE
SODIUM 2-(4-METHOXYPHENOXY)PROPANOATE
(Z)-3 & (E)-2-HEXENYL PROPIONATE
3-(METHYLTHIO)HEXYL ACETATE
L-MENTHOL ETHYLENE GLYCOL CARBONATE
L-MENTHOL 1- AND 2-PROPYLENE GLYCOL CARBONATE
CIS- AND TRANS-MENTHONE-8-THIOACETATE
MONO-MENTHYL SUCCINATE
3-ACETYLMERCAPTOHEXYL ACETATE
ETHYL 2-(METHYLTHIO)ACETATE
CIS- AND TRANS-P-1(7),8-MENTHADIEN-2-YL ACETATE
3-MERCAPTOHEXYL ACETATE
3-MERCAPTOHEXYL BUTYRATE
3-MERCAPTOHEXYL HEXANOATE
3-MERCAPTO-3-METHYLBUTYL FORMATE
METHYL (E)-2-(Z)-4- DECADIENOATE
S-METHYL 3-METHYLBUTANETHIOATE
3-(METHYLTHIO)PROPYL ACETATE
8-OCIMENYL ACETATE
(Z)-5-OCTENYL PROPIONATE
2-PENTYL BUTYRATE
PRENYL THIOACETATE
CIS-3-HEXENYL ANTHRANILATE
TRANS-2-HEXENYL BUTYRATE
3-HEXENYL 2-HEXENOATE
CIS-3-HEXENYL ISOBUTYRATE
CIS-3-HEXENYL TIGLATE
CIS-3-HEXENYL PROPIONATE
3-HEXENYL 2-OXOPROPIONATE
CIS-3-HEXENYL VALERATE
(E,Z)-2,6-NONADIEN-1-OL ACETATE
(E,Z)-3,6-NONADIEN-1-OL ACETATE
PHENYL SALICYLATE
CIS-4-DECENYL ACETATE
2,5-DIMETHYL-3-OXO-(2H)-FUR-4-YL BUTYRATE
CIS AND TRANS-2,5-DIMETHYLTETRAHYDRO-3-FURYL
THIOACETATE
ETHYL 4-(ACETYLTHIO)BUTYRATE
ETHYL CIS-4-HEPTENOATE
ETHYL 5-HEXENOATE
(+/−) ETHYL 3-MERCAPTOBUTYRATE
ETHYL 5-(METHYLTHIO)VALERATE
(+/−) HEPTAN-3-YL ACETATE
(+/−) HEPTAN-2-YL BUTYRATE
(Z)-3-HEXENYL (E)-2-BUTENOATE
ISOPRENYL ACETATE
D,L-MENTHOL(+/−)-PROPYLENE GLYCOL CARBONATE
METHYL 2-METHYL-2-PROPENOATE
L-MONOMENTHYL GLUTARATE
(+/−) NONAN-3-YL ACETATE
4-PENTENYL ACETATE
2-PENTYL ACETATE
PHENETHYL ISOTHIOCYANATE
ETHYL 3-ACETOXY-2-METHYL BUTYRATE
O-ETHYL S-(2-FURYLMETHYL)THIOCARBONATE
GERANYL TIGLATE
METHYL 5-ACETOXYHEXANOATE
ALLYL THIOHEXANOATE
CITRONELLYL ANTHRANILATE
DIISOPENTYL THIOMALATE
(+/−)-TRANS- AND CIS-4,8-DIMETHYL-3,7-NONADIEN-2-YL
ACETATE
ETHYL CIS-3-HEXENOATE
2,4-HEXADIENYL PROPIONATE
2,4-HEXADIENYL ACETATE
2,4-HEXADIENYL BUTYRATE
2,4-HEXADIENYL ISOBUTYRATE
HEXYL 3-MERCAPTOBUTANOATE
(+/−)-ISOBUTYL 3-METHYLTHIOBUTYRATE
METHIONYL BUTYRATE
METHYL CIS-3-HEXENOATE
METHYL CIS-5-OCTENOATE
METHYL 3-(METHYLTHIO)BUTANOATE
METHYL 3-MERCAPTOBUTANOATE
S-METHYL PROPANETHIOATE
6-METHYL-5-HEPTEN-2-YL ACETATE
CIS-3-OCTENYL PROPIONATE
PRENYL ACETATE
PRENYL BENZOATE
PRENYL CAPROATE
PRENYL FORMATE
PRENYL ISOBUTYRATE
GUM ARABIC, HYDROGEN OCTENYLBUTANE DIOATE
METHYL 10-UNDECENOATE
N-LACTOYL ETHANOLAMINE PHOSPHATE
(+/−)-ETHYL 2-HYDROXY-2-METHYLBUTYRATE
(+/−)-ETHYL 2-HYDROXY-3-METHYLVALERATE
3-MERCAPTOHEPTYL ACETATE
ETHYL TRANS-2-METHYL-2-PENTENOATE
2-METHYLBUTYL 3-METHYL-2-BUTENOATE
L-MENTHYL (R,S)-3-HYDROXYBUTYRATE
PHENETHYL DECANOATE
3-MERCAPTO-3-METHYL-1-BUTYL ACETATE
(+/−)-3-MERCAPTO-1-BUTYL ACETATE
L-MENTHYL ACETOACETATE
HEXYL HEPTANOATE
HEXYL DECANOATE
ISOBUTYL 10-UNDECENOATE
ETHYL 3-OCTENOATE
(+/−)-ETHYL 3-HYDROXY-2-METHYLBUTYRATE
(+/−)-ETHYL 3-MERCAPTO-2-METHYLBUTANOATE
DIMETHYLBENZYL CARBINYL HEXANOATE
TRANS-3-HEXENYL ACETATE
4-(METHYLTHIO)BUTYL ISOTHIOCYANATE
6-(METHYLTHIO)HEXYL ISOTHIOCYANATE
5-(METHYLTHIO)PENTYL ISOTHIOCYANATE
3-BUTENYL ISOTHIOCYANATE
2-BUTYLISOTHIOCYANATE
5-HEXENYL ISOTHIOCYANATE
HEXYL ISOTHIOCYANATE
ISOBUTYL ISOTHIOCYANATE
4-PENTENYL ISOTHIOCYANATE
3-(METHYLTHIO)PROPYL HEXANOATE
ETHYL 5-ACETOXYOCTANOATE
ETHYL 5-HYDROXYDECANOATE
METHYL 3-ACETOXY-2-METHYLBUTYRATE
ETHYL 3-HYDROXYOCTANOATE
METHYL 3-ACETOXYOCTANOATE
ETHYL 2-ACETYLOCTANOATE
PROPYLENEGLYCOL DIBUTYRATE
PROPYLENEGLYCOL MONO-2-METHYLBUTYRATE
PROPYLENEGLYCOL DI-2-METHYLBUTYRATE
PROPYLENEGLYCOL MONOHEXANOATE
PROPYLENEGLYCOL MONOHEXANOATE
PROPYLENEGLYCOL DIHEXANOATE
METHYL LEVULINATE
PROPYL LEVULINATE
ISOAMYL LEVULINATE
PROPYLENEGLYCOL MONOBUTYRATE
CIS-3-HEXENYL ACETOACETATE
MENTHYL FORMATE
MENTHYL PROPIONATE
3,3,5-TRIMETHYLCYCLOHEXYL ACETATE
L-MENTHYL BUTYRATE
PINOCARVYL ISOBUTYRATE
CIS,CIS-3,6-NONADIENYL ACETATE
TRANS-2-NONENYL ACETATE
CIS-3-NONENYL ACETATE
CIS-6-NONENYL ACETATE
DIHYDROGALANGAL ACETATE
METHYL ISOBUTANETHIOATE
TREHALOSE, DIHYDRATE
4-FORMYL-2-METHOXYPHENYL 2-HYDROXYPROPANOATE
GUAIACOL BUTYRATE
GUAIACOL ISOBUTYRATE
GUAIACOL PROPIONATE
ETHYL 5-HYDROXYOCTANOATE
2-PHENOXYETHYL PROPIONATE
BENZYL LEVULINATE
METHYL BETA-PHENYLGLYCIDATE
(+)-2-METHYLTETRAHYDROFURAN-3-THIOL ACETATE
CINNAMYL BENZOATE
SUCROSE MONOPALMITATE
ETHYL 2-MERCAPTO-2-METHYLPROPIONATE
O-ETHYL S-1-METHOXYHEXAN-3-YL CARBONOTHIOATE
4-METHYLPENTYL 4-METHYLVALERATE
CIS-3-HEXENYL SALICYLATE
N-ACETYL GLUTAMATE
ETHYL 3-(2-HYDROXYPHENYL)PROPANOATE
PRENYL THIOISOBUTYRATE
PRENYL THIOISOVALERATE
ETHYL 5-FORMYLOXYDECANOATE
Pinocarvyl acetate
Ethyl-2-(4-hydroxy-3-methoxy-phenyl)acetate
trans-1-Ethyl-2-methylpropyl 2-butenoate
2-(5-Isopropyl-2-methyl- tetrahydrothiophen-2-yl)-ethy acetate
3-Phenylpropyl 2-(4-hydroxy-3-methoxyphenyl)acetate
cis-5-Dodecenyl acetate
(2E,4E)-2,4-Decadien-1-ol acetate
2-Phenoxyethyl 2-(4-hydroxy-3-methoxyphenyl)acetate

Table 8 lists examples of ketones that may be used as ingredients in the duplicate beverages described herein.

TABLE 8
KETONES

ACETOIN
ACETOPHENONE
ALLYL ALPHA-IONONE
2-BUTANONE
CARVONE
GAMMA-DECALACTONE
DELTA-DECALACTONE
2,4-DIMETHYLACETOPHENONE
GAMMA-DODECALACTONE
DELTA-DODECALACTONE
D-FENCHONE
4-(2-FURYL)-3-BUTEN-2-ONE
GAMMA-HEPTALACTONE
2-HEPTANONE
4-HEPTANONE
OMEGA-6-HEXADECENLACTONE
GAMMA-HEXALACTONE
2,3-HEXANEDIONE
ALPHA-IONONE
BETA-IONONE
ALPHA-IRONE
MALTOL
MENTHONE
1-(P-METHOXYPHENYL)-1-PENTEN-3-ONE
4′-METHYLACETOPHENONE
METHYLCYCLOPENTENOLONE
6-METHYL-5-HEPTEN-2-ONE
METHYL-ALPHA-IONONE
METHYL-BETA-IONONE
METHYL-DELTA-IONONE
METHYL BETA-NAPHTHYL KETONE
4-METHYL-1-PHENYL-2-PENTANONE
GAMMA-NONALACTONE
2-NONANONE
GAMMA-OCTALACTONE
2-OCTANONE
OMEGA-PENTADECALACTONE
2,3-PENTANEDIONE
4-PHENYL-3-BUTEN-2-ONE
PIPERINE
D-PIPERITONE
PULEGONE
ISOPULEGONE
GAMMA-UNDECALACTONE
GAMMA-VALEROLACTONE
ZINGERONE
3-ETHYL-2-HYDROXY-2-CYCLOPENTEN-1-ONE
5-ETHYL-3-HYDROXY-4-METHYL-2(5H)-FURANONE
2-FURYL METHYL KETONE
NOOTKATONE
DELTA-HEXALACTONE
1-HYDROXY-2-BUTANONE
4-HYDROXY-2,5-DIMETHYL-3(2H)-FURANONE
GAMMA-IONONE
P-MENTHAN-2-ONE
P-MENTHA-8-THIOL-3-ONE
3-METHYL-2-(2-PENTENYL)-2-CYCLOPENTEN-1-ONE
METHYL 2-PYRROLYL KETONE
DELTA-OCTALACTONE
2-SEC-BUTYLCYCLOHEXANONE
3,4-DIMETHYL-1,2-CYCLOPENTADIONE
1-METHYL-2,3-CYCLOHEXADIONE
CYCLOHEPTADECA-9-EN-1-ONE
3-METHYL-1-CYCLOPENTADECANONE
3-NONANONE
ETHYL MALTOL
2-ACETOXY-3-BUTANONE
3-DECEN-2-ONE
2,6-DIMETHYL-4-HEPTANONE
ISOJASMONE
P-MENTH-8-EN-2-ONE
2-OCTEN-4-ONE
DIHYDRO-ALPHA-IONONE
ALPHA-1-(2,6,6-TRIMETHYL-2-CYCLOHEXEN-1-YL)-2-BUTEN-1-
ONE
2,5-DIMETHYL-4-METHOXY-3(2H)-FURANONE
METHYL 1-ACETOXYCYCLOHEXYL KETONE
5-METHYL-2-HEPTEN-4-ONE
DIHYDRONOOTKATONE
GAMMA-METHYLDECALACTONE
NEOHESPERIDIN DIHYDROCHALCONE
CYCLOIONONE
4-[(2-FURANMETHYL)THIO]-2-PENTANONE
5-(CIS-3-HEXENYL)DIHYDRO-5-METHYL-2(3H)FURANONE
2-METHYL-3-(1-OXOPROPOXY)-4H-PYRAN-4-ONE
3-NONEN-2-ONE
3-DECANONE
(E) & (Z)-4,8-DIMETHYL-3,7-NONADIEN-2-ONE
3(2)-HYDROXY-5-METHYL-2(3)-HEXANONE
4-MERCAPTO-4-METHYL-2-PENTANONE
(+/−) 3-METHYL-GAMMA-DECALACTONE
2-METHYLHEPTAN-3-ONE
(E)-6-METHYL-3-HEPTEN-2-ONE
(E,E)-3,5-OCTADIEN-2-ONE
DIHYDROMINTLACTONE
3-HYDROXY-4-PHENYLBUTAN-2-ONE
2,3-OCTANEDIONE
TUBEROSE LACTONE
DEHYDRONOOTKATONE
1-(3-HYDROXY-5-METHYL-2-THIENYL)ETHANONE
4-MERCAPTO-2-PENTANONE
2-METHOXYACETOPHENONE
L-PIPERITONE
2-(TRANS-2-PENTENYL)CYCLOPENTANONE
3,9-DIMETHYL-6-(1-METHYLETHYL)-1,4-
DIOXASPIRO[4.5]DECAN-2-ONE
CIS- AND TRANS-L-MERCAPTO-P-MENTHAN-3-ONE
TRANS-2-NONEN-4-ONE
1,1′-(TETRAHYDRO-6A-HYDROXY-2,3A,5- TRIMETHYLFURO[2,3-
D]-1,3-DIOXOLE-2,5-DIYL)BIS-ETHANONE
5,7-DIHYDROXY-2-(3-HYDROXY-4-METHOXY-PHENYL)-
CHROMAN-4-ONE
5-PENTYL-3H-FURAN-2-ONE
5-NONEN-TRANS-2-ONE
4-OCTEN-3-ONE
4-HYDROXYACETOPHENONE
(+/−)-[R-(E)]-5-ISOPROPYL-8-METHYLNONA-6,8-DIEN-2-ONE
3-(4-HYDROXY-PHENYL)-1-(2,4,6-TRIHYDROXY-PHENYL)-
PROPAN-1-ONE
DELTA-OCTADECALACTONE
ORIN LACTONE
HYDROXYACETONE
NARINGIN DIHYDROCHALCONE
2-CYCLOPENTYLCYCLOPENTANONE
8,9-DEHYDROTHEASPIRONE
2,2,6,7-TETRAMETHYLBICYCLO[4.3.0]NONA-4,9(1)-DIEN-8-ONE
1-(4-HYDROXY-3-METHOXYPHENYL)DECAN-3-ONE
4-AMINO-5,6-DIMETHYLTHIENO[2,3-D]PYRIMIDIN-2(1H)-ONE
1-(2-FURFURYLTHIO)-PROPANONE
(±)-3-HYDROXY-3-METHYL-2,4-NONANEDIONE
YUZUNONE
9-DECEN-2-ONE
1-(2-HYDROXY-4-METHYLCYCLOHEXYL)ETHANONE
3,5-UNDECADIEN-2-ONE
1-(2,4-DIHYDROXYPHENYL)-3-(3-HYDROXY-4-
METHOXYPHENYL)PROPAN-1-ONE
5-MERCAPTO-5-METHYL-3-HEXANONE
(+/−)-2-Mercapto-5-methylheptan-4-one
(+/−)-4-Hydroxy-6-methyl-2-heptanone
(2R)-3′,5-Dihydroxy-4′-methoxyflavanone
(S)-1-(3-(((4-amino-2,2-dioxido-1H-benzo[c][1,2,6]thiadiazin-5-
yl)oxy)methyl)piperidin-1-yl)-3-methylbutan-1-one
1-(4-Methyl-3-cyclohexen-1-yl)-ethanone
2-Pyrrolidone
7,8-Dihydroxyflavone
(R)-5-hydroxy-4-(4′-hydroxy-3′-methoxyphenyl)-7-methylchroman-2-one
(±)-Tetrahydronootkatone
(3S,5R,8S)-3,8-Dimethyl-5-prop-1-en-2-yl-3,4,5,6,7,8-hexahydro-2H-
azulen-1-one
4-(4-Methyl-3-penten-1-yl)-2(5H)-furanone
4-(1-Menthoxy)-2-butanone
3-(3-Hydroxy-4-methoxy-phenyl)-1-(2,4,6-trihydroxyphenyl)propan-1-one
damascenone

Table 9 lists examples of pyrazines that may be used as ingredients in the duplicate beverages described herein.

TABLE 9
PYRAZINES

ACETYLPYRAZINE
2-ISOBUTYL-3-METHOXYPYRAZINE
2-ISOBUTYL-3-METHYLPYRAZINE
2,3-DIETHYLPYRAZINE
2-ETHYL-3,(5 OR 6)-DIMETHYLPYRAZINE
3-ETHYL-2,6-DIMETHYLPYRAZINE
2-ETHYL-5-METHYLPYRAZINE
2-ETHYL-3-METHYLPYRAZINE
2,5 OR 6-METHOXY-3-METHYLPYRAZINE (MIXTURE OF
ISOMERS)
2-METHYL-3-,5 OR 6-(FURFURYLTHIO)PYRAZINE (MIXTURE OF
ISOMERS)
2-METHYL-5-VINYLPYRAZINE (RE-GRAS)
2,3,5,6-TETRAMETHYLPYRAZINE
2,3,5-TRIMETHYLPYRAZINE
2-METHOXY-3-(1-METHYLPROPYL)PYRAZINE
2,5-DIETHYL-3-METHYLPYRAZINE
3,5-DIETHYL-2-METHYLPYRAZINE
2-ETHYL-6-METHYLPYRAZINE
2-ISOPROPYLPYRAZINE
PROPYLPYRAZINE
2-ACETYL-3-METHYLPYRAZINE
PYRAZINE
5-ETHYL-2,3-DIMETHYLPYRAZINE
2(3),5-DIMETHYL-6,7-DIHYDRO-5H-CYCLOPENTAPYRAZINE
2,3-dimethylpyrazine

Table 10 lists examples of terpenes that may be used as ingredients in the duplicate beverages described herein.

TABLE 10
TERPENES

ACETANISOLE
TRANS-ANETHOLE
BUTYLATED HYDROXYANISOLE
BUTYLATED HYDROXYTOLUENE
BETA-CARYOPHYLLENE
P-CYMENE
M-DIMETHOXYBENZENE
ESTRAGOLE
INDOLE
D-LIMONENE
LINALOOL
P-METHYLANISOLE
MYRCENE
ALPHA-PINENE
BETA-PINENE
P-PROPYLANISOLE
SKATOLE
TERPINOLENE
TETRAHYDROLINALOOL
P,ALPHA-DIMETHYLSTYRENE
2,4-DIMETHYL-5-VINYLTHIAZOLE
1-ETHYL-2-ACETYLPYRROLE
1-METHYL-2-ACETYLPYRROLE
BENZOTHIAZOLE
N-FURFURYLPYRROLE
BISABOLENE
2-FORMYL-6,6-DIMETHYLBICYCLO(3.1.1)HEPT-2-ENE
VALENCENE
3,7-DIMETHYL-1,3,6-OCTATRIENE
2-ISOPROPYL-4-METHYLTHIAZOLE
P-MENTHA-1,3-DIENE
P-MENTHA-1,4-DIENE
1,4-CINEOLE
LINALOOL OXIDE
1-ETHOXY-3-METHYL-2-BUTENE
1,3,5-UNDECATRIENE
1,2-DIMETHOXYBENZENE
DELTA-3-CARENE
ALPHA-FARNESENE
2,5-DIMETHYLTHIAZOLE
TRANS- AND CIS-1-METHOXY-1-DECENE
ALPHA -IONENE
TRANS-2-TRANS-4-NONADIENE
1-OCTENE
MIXTURE OF METHYL CYCLOHEXADIENE AND METHYLENE
CYCLOHEXENE
MIXTURE OF METHYL CYCLOHEXADIENE AND METHYLENE
CYCLOHEXENE
LINALOOL OXIDE PYRANOID
2-ETHYL-2,5-DIHYDRO-4-METHYLTHIAZOLE
1-CYCLOPROPANEMETHYL-4-METHOXYBENZENE

Table 11 lists examples of other volatile organic compounds (VOCs) that may be used as ingredients in the duplicate beverages described herein.

TABLE 11
OTHER VOCs

(TRI-)ACETIN
ALLYL DISULFIDE
ALLYL MERCAPTAN
ALLYL SULFIDE
BENZOIN
BENZYL MERCAPTAN
D-CAMPHOR
DIACETYL
DIHYDROCARVEOL (ISOMER UNSPECIFIED)
DIHYDROCOUMARIN
ETHYL ACONITATE (MIXED ESTERS)
ETHYL NITRITE
ETHYL VANILLIN
FURFURYL MERCAPTAN
3-(2-FURYL)ACROLEIN
2-HEXYL-5 OR 6-KETO-1,4-DIOXANE
MENTHYL ACETATE (ISOMER UNSPECIFIED)
6-METHYLCOUMARIN
2-METHYL-3(2-FURYL)ACROLEIN
METHYL MERCAPTAN
METHYL SULFIDE
BETA-NAPHTHYL ETHYL ETHER
1,3-NONANEDIOL ACETATE (MIXED ESTERS)
2-(3-PHENYLPROPYL)TETRAHYDROFURAN
PIPERIDINE
PYRIDINE
RUM ETHER
SULFUR DIOXIDE
TERPINYL ACETATE (ISOMER MIXTURE)
TOLUALDEHYDE GLYCERYL ACETAL (MIXED O-, M-, P-)
TOLUALDEHYDES (MIXED O, M, P)
VANILLIN
ALLYL METHYL DISULFIDE
2,2′-(DITHIODIMETHYLENE)-DIFURAN
FURFURYL METHYL ETHER
FURFURYL METHYL SULFIDE
FURFURYL ISOPROPYL SULFIDE
PHENYL DISULFIDE
PROPENYL PROPYL DISULFIDE
PROPYL DISULFIDE
PYRAZINYL METHYL SULFIDE
4,5,6,7-TETRAHYDRO-3,6-DIMETHYLBENZOFURAN
SPIRO(2,4-DITHIA-1-METHYL-8-OXABICYCLO(3.3.0)OCTANE-
3,3′-(1′-OXA-2′-METHYL)-CYCLOPENTANE)
2-PENTYLFURAN
3-N-BUTYLPHTHALIDE
DI(BUTAN-3-ONE-1-YL) SULFIDE
METHYL LINOLEATE (48%) METHYL LINOLENATE (52%)
MIXTURE
2,2,4-TRIMETHYL-1,3-OXACYCLOPENTANE
D,L-VALINE
DICYCLOHEXYL DISULFIDE
N-ETHYL-2-ISOPROPYL-5-METHYLCYCLOHEXANE
CARBOXAMIDE
CANDELILLA WAX (WAX FROM STEMS AND BRANCHES OF
EUPHORBIA CERIFERA)
2,3 OR 10-MERCAPTOPINANE
1,2-DI((1′-ETHOXY)ETHOXY)PROPANE
DIMETHYL DISULFIDE
L-PHENYLALANINE
1,2,3-TRIS((1′-ETHOXY)ETHOXY)PROPANE
4-ACETYL-2-METHYLPYRIMIDINE
2-ETHYLFURAN
3-METHYL-1,2,4-TRITHIANE
BETA-NAPHTHYL ISOBUTYL ETHER
THAUMATIN
2,5-DIETHYLTETRAHYDROFURAN
HYDROGEN SULFIDE
JAMBU OLEORESIN
SCLAREOLIDE
VANILLYL BUTYL ETHER
2-ISOPROPYL-N,2,3-TRIMETHYLBUTYRAMIDE
VANILLYL ETHYL ETHER
DL-ALANINE
L-ARGININE
DIETHYL SULFIDE
METHYL ETHYL SULFIDE
BIS-(METHYLTHIO)METHANE
PHENYLETHYL MERCAPTAN
1-PYRROLINE
DIISOPROPYL TRISULFIDE
ISOPENTYLIDENE ISOPENTYLAMINE
TRITHIAHEXANE-2,3,5
BUTYL ETHYL DISULFIDE
DIETHYL TRISULFIDE
(+/−)-3,5-DIETHYL-1,2,4-TRITHIOLANE
ETHYL METHYL DISULFIDE
ETHYL PROPYL DISULFIDE
ETHYL PROPYL TRISULFIDE
2-HEXYL-4,5-DIMETHYL-1,3-DIOXOLANE
L-MENTHYL METHYLETHER
(+/−)-1-PHENYLETHYLMERCAPTAN
2-PROPIONYLPYRROLINE
2-PROPIONYL-2-THIAZOLINE
(+/−)-1-ACETOXY-1-ETHOXYETHANE
MIXTURE OF 3,6-DIETHYL-1,2,4,5-TETRATHIANE AND 3,5-
DIETHYL-1,2,4-TRITHIOLANE
2,4-DIMETHYL-1,3-DIOXOLANE
DIVANILLIN
(+/−)-2,8-EPITHIO-CIS-P-MENTHANE
ISOAMBRETTOLIDE
N-ISOBUTYLDECA-TRANS-2-TRANS-4-DIENAMIDE
BETAINE
ISOQUERCITRIN, ENZYMATICALLY MODIFIED
GLYCEROL ESTER OF ROSIN
(+/−)-N,N-DIMETHYL MENTHYL SUCCINAMIDE
N-(HEPTAN-4-YL)BENZO[D][1,3]DIOXOLE-5-CARBOXAMIDE
N-GLUCONYL ETHANOLAMINE
N-LACTOYL ETHANOLAMINE
CIS- AND TRANS-2-ISOBUTYL-4-METHYL-1,3-DIOXOLANE
CIS- AND TRANS-2-ISOPROPYL-4-METHYL-1,3-DIOXOLANE
METHYL HEXYL ETHER
5-ACETYL-2,3-DIHYDRO-1,4-THIAZINE
N-[(ETHOXYCARBONYL)METHYL)-P-MENTHANE-3-
CARBOXAMIDE
DI-(1-PROPENYL)-SULFIDE (MIXTURE OF ISOMERS)
2,4-DIMETHYLPYRIDINE
7-DECEN-4-OLIDE
MYRICITRIN
(+/−)-CIS- AND TRANS-2-PENTYL-4-PROPYL-1,3-
OXATHIANE
2-PENTENYL-4-PROPYL-1,3-OXATHIANE (MIXTURE OF
ISOMERS)
NEROLIDOL OXIDE
4-(2-PROPENYL)PHENYL-BETA-D-GLUCOPYRANOSIDE
METHYL OCTYL SULFIDE
MYRCENYL METHYL ETHER
REBAUDIOSIDE A
BUTYL BETA-NAPHTHYL ETHER
ISOAMYL PHENETHYL ETHER
L-8-P-MENTHENE-1,2-EPOXIDE
DIGERANYL ETHER
(2E,6E/Z,8E)-N-(2-METHYLPROPYL)-2,6,8-DECATRIENAMIDE
(±)-4-METHYL-2-PROPYL-1,3-OXATHIANE
N-(2-METHYLCYCLOHEXYL)-2,3,4,5,6-
PENTAFLUOROBENZAMIDE
5-ISOPROPYL-2,6-DIETHYL-2-METHYLTETRAHYDRO-2H-PYRAN
(1R,2S,5R)-N-(4-METHOXYPHENYL)-5-METHYL-2-(1-
METHYLETHYL)CYCLOHEXANECARBOXAMIDE
3-[(4-AMINO-2,2-DIOXIDO-1H-2,1,3-BENZOTHIADIAZIN-5-
YL)OXY]-2,2-DIMETHYL-N-PROPYLPROPANAMIDE
3-[(4-AMINO-2,2-DIOXIDO-1H-2,1,3-BENZOTHIADIAZIN-5-
YL)OXY]-2,2-DIMETHYL-N-PROPYLPROPANAMIDE
BETA-NAPHTHYL METHYL ETHER
3′,7-DIHYDROXY-4′-METHOXYFLAVAN
L-THREONINE
L-ALANYL-L-GLUTAMINE
2-(3,4-DIHYDROXYPHENYL)-5,7-DIHYDROXY-4-CHROMANON
REBAUDIOSIDE C
GLUCOSYL STEVIOL GLYCOSIDES
GLUTAMYL-NORVALYL-GLYCINE
GLUTAMYL-NORVALINE
STEVIOSIDE
2-ISOPROPYL-4-METHYL-3-THIAZOLINE
(E)-N-[2-(1,3-BENZODIOXOL-5-YL)ETHYL]-3-(3,4-
DIMETHOXYPHENYL)PROP-2-ENAMIDE
(E)-3-Benzo[1,3]dioxol-5-yl-N,N-diphenyl-2-propenamide
(3R,3S)-3-[[(4-amino-2,2-dioxido-1H-2,1,3-benzothiadiazin-5-
yl)oxy]methyl]-N-cyclopentyl-2-oxo-3-piperidinecarboxamide
(+/−)-Naringenin
N-Ethyl-5-methyl-2-(1-methylethenyl)cyclohexanecarboxamide
2-(4-Methylphenoxy)-N-(1H-pyrazol-3-yl)-N-(thiophen-2-
ylmethyl)acetamide
(2S)-3′,7-Dihydroxy-8-methyl-4′-methoxyflavan
2-Ethyl-4-methyl-1,3-dithiolane
L-rose oxide

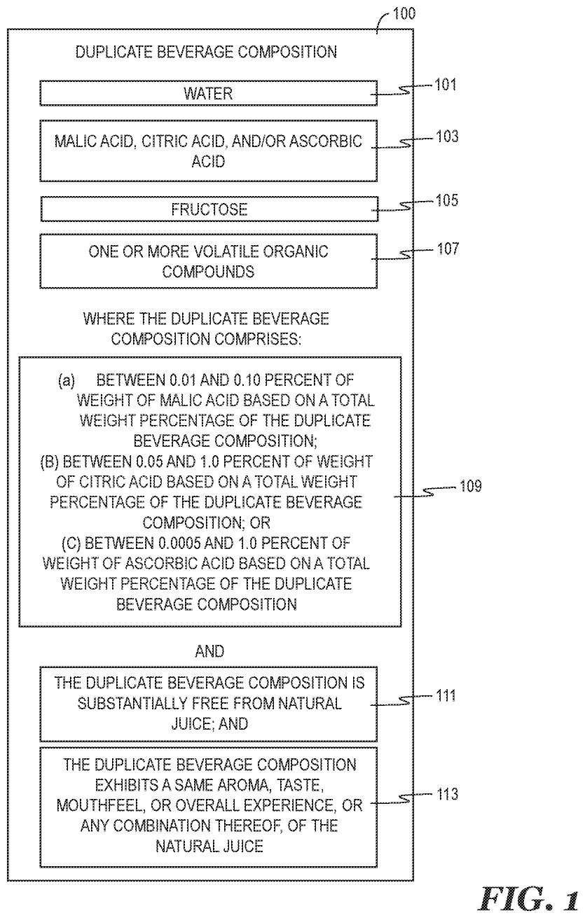

FIG. 1 is a diagram illustrating an example duplicate beverage composition 100 in accordance with a number of embodiments of the disclosure. As shown in FIG. 1, the duplicate beverage composition 100 contains water 101, at least one of Malic Acid, Citric Acid, or Ascorbic Acid (as shown in block 103), fructose 105, and one or more volatile organic compounds 107. In the embodiment illustrated in FIG. 1, the duplicate beverage composition 100 contains (a) between 0.01 and 0.10 percent of weight of Malic Acid based on a total weight percentage of the duplicate beverage composition, (b) between 0.05 and 1.0 percent of weight of Citric Acid based on a total weight percentage of the duplicate beverage composition; or (c) between 0.0005 and 1.0 percent of weight of Ascorbic Acid based on a total weight percentage of the duplicate beverage composition, as shown in block 109. As discussed herein, the duplicate beverage composition 100 is substantially free from natural juice (as shown at block 111), and the duplicate beverage composition 100 exhibits a same aroma, taste, mouthfeel, or overall experience, or any combination thereof, of the natural juice (as shown at block 113).

In some embodiments, the duplicate beverage composition 100 comprises between 0.0005 and 1.0 percent of weight of the volatile organic compounds 107 based on a total weight percentage of the duplicate beverage composition 100. In some embodiments, the duplicate beverage composition comprises between 1.0 and 20.0 percent of weight of the fructose 105 based on a total weight percentage of the duplicate beverage composition 100. In some embodiments, the duplicate beverage composition 100 further comprises Glycerin. In such embodiments, the duplicate beverage composition 100 comprises between 1.0 and 5.0 percent of weight of the Glycerin based on a total weight percentage of the duplicate beverage composition 100. In some embodiments, the duplicate beverage composition 100 comprises between 70.0 and 98.0 percent of weight of Water based on a total weight percentage of the duplicate beverage composition 100.

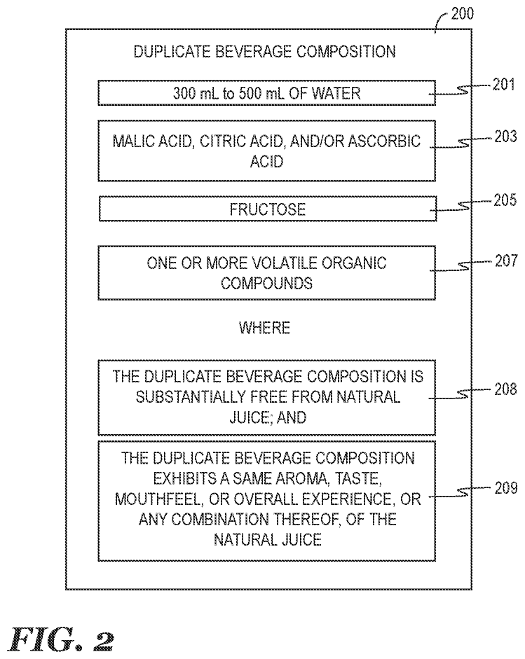

FIG. 2 is a diagram illustrating an example duplicate beverage composition 200 in accordance with a number of embodiments of the disclosure. As shown in FIG. 2, the duplicate beverage composition 200 contains 300 to 500 mL of water 101, at least one of Malic Acid, Citric Acid, or Ascorbic Acid (as shown in block 203), fructose 205, and one or more volatile organic compounds 207. In the embodiment illustrated in FIG. 2, the duplicate beverage composition 200 is substantially free from natural juice (as shown at block 208), and the duplicate beverage composition 200 exhibits a same aroma, taste, mouthfeel, or overall experience, or any combination thereof, of the natural juice (as shown at block 209).

In some embodiments, the duplicate beverage composition 200 contains around 0.25 grams of malic acid, around 2.5 grams of citric acid, and/or around 0.1 grams of ascorbic acid. Further, as described herein, the volatile organic compounds form a flavor base for the duplicate beverage composition 200.

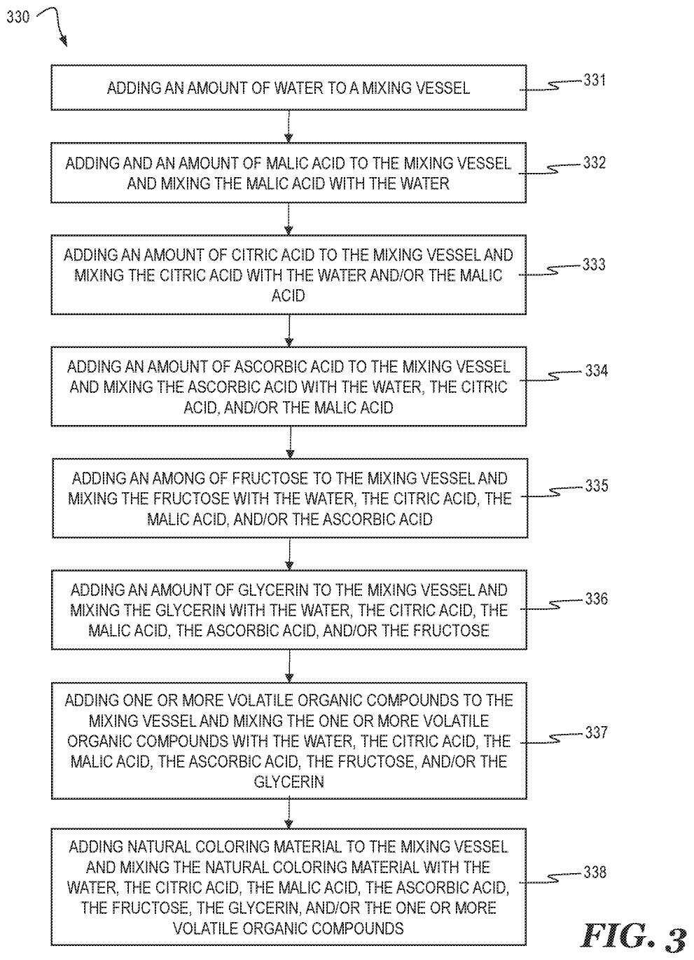

FIG. 3 is a flow diagram corresponding to a method 330 for making a duplicate beverage composition in accordance with a number of embodiments of the disclosure. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 331, the method 330 can include adding an amount of water to a mixing vessel. The mixing vessel may be a glass mixing vessel, although embodiments are not so limited. As discussed herein, the beverage composition can comprise between 70.0 and 98.0 percent of weight of water based on a total weight percentage of the beverage composition and, accordingly, an amount of water within these percentages of weight based on the total weight percentage of the beverage composition can be added to the mixing vessel. In some embodiments, 300 mL to 500 mL of water may be added to the mixing vessel.

At block 332, the method 330 can include adding and an amount of malic acid to the mixing vessel and mixing the malic acid with the water. In some embodiments, the method 330 includes adding around 0.25 grams of malic acid to the mixing vessel and mixing the malic acid with the water. The term “around,” particularly in the context of weights and measurements, is intended to mean that slight variation in such weights or measurements may occur within the scope of the disclosure. For example, 0.23 grams of malic acid or 0.27 grams of malic acid (or any value therebetween) may be added to the mixing vessel without departing from the scope of the disclosure. Further, the amount of malic acid added to the mixing vessel may vary based on the amount of water in the mixing vessel, among other factors.

At block 333, the method 330 can include adding an amount of citric acid to the mixing vessel and mixing the citric acid with the water and/or the malic acid. In some embodiments, the method 330 includes adding around 2.5 grams of citric acid to the mixing vessel and mixing the citric acid with the water. However, the amount of citric acid added to the mixing vessel may vary in accordance with the disclosure. For example, 2.0 grams of citric acid or 3.0 grams of citric acid (or any value therebetween) may be added to the mixing vessel without departing from the scope of the disclosure. Further, the amount of citric acid added to the mixing vessel may vary based on the amount of water in the mixing vessel, among other factors.

At block 334, the method 330 can include adding an amount of ascorbic acid to the mixing vessel and mixing the ascorbic acid with the water, the citric acid, and/or the malic acid. In some embodiments, the method 330 includes adding around 0.1 grams of ascorbic acid to the mixing vessel and mixing the citric acid and/or the malic acid with the water. However, the amount of ascorbic acid added to the mixing vessel may vary in accordance with the disclosure. For example, 0.05 grams of ascorbic acid or 0.15 grams of ascorbic acid (or any value therebetween) may be added to the mixing vessel without departing from the scope of the disclosure. Further, the amount of ascorbic acid added to the mixing vessel may vary based on the amount of water in the mixing vessel, among other factors.

At block 335, the method 330 can include adding an among of fructose to the mixing vessel and mixing the fructose with the water, the citric acid, the malic acid, and/or the ascorbic acid. In some embodiments, the method 330 includes adding around 50 grams of fructose to the mixing vessel and mixing the citric acid, the malic acid, and/or the ascorbic acid with the water. However, the amount of fructose added to the mixing vessel may vary in accordance with the disclosure. For example, 40 grams of fructose or 60 grams of fructose (or any value therebetween) may be added to the mixing vessel without departing from the scope of the disclosure. Further, the amount of fructose added to the mixing vessel may vary based on the amount of water in the mixing vessel, among other factors.

At block 336, the method 330 can include adding an amount of glycerin to the mixing vessel and mixing the glycerin with the water, the citric acid, the malic acid, the ascorbic acid, and/or the fructose. In some embodiments, the method 330 includes adding around 12.5 grams of glycerin to the mixing vessel and mixing the citric acid, the malic acid, the ascorbic acid, and/or the fructose with the water. However, the amount of glycerin added to the mixing vessel may vary in accordance with the disclosure. For example, 10.5 grams of glycerin or 14.5 grams of glycerin (or any value therebetween) may be added to the mixing vessel without departing from the scope of the disclosure. Further, the amount of glycerin added to the mixing vessel may vary based on the amount of water in the mixing vessel, among other factors.

At block 337, the method 330 can include adding one or more volatile organic compounds to the mixing vessel and mixing the one or more volatile organic compounds with the water, the citric acid, the malic acid, the ascorbic acid, the fructose, and/or the glycerin. In some embodiments, a total mass per liter of the one or more organic volatile compounds is between 200 milligrams/liter and 230 milligrams/liter of a total amount of the beverage. Further, as discussed herein, the one or more volatile organic compounds may be selected from a group consisting of Acetone, Ethyl Acetate, Butanoic acid, 2-methyl-, ethyl ester, Camphene, Myrcene, Pinene, Phellandrene, Pinene, Terpinene, Limonene, Terpinene, Terpinolene, Linalool, Citral, and Geraniol.

At block 338, the method 330 can include adding natural coloring material to the mixing vessel and mixing the natural coloring material with the water, the citric acid, the malic acid, the ascorbic acid, the fructose, the glycerin, and/or the one or more volatile organic compounds.

In some embodiments, the water, the citric acid, the malic acid, the ascorbic acid, the fructose, the glycerin, the one or more volatile organic compounds, and the natural coloring material are added to the mixing vessel in no particular order, while in other embodiments the water, the citric acid, the malic acid, the ascorbic acid, the fructose, the glycerin, the one or more volatile organic compounds, and the natural coloring material are added to the mixing vessel in a particular order.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A duplicate beverage composition comprising:
water,
at least one of Malic Acid, Citric Acid, or Ascorbic Acid;
Fructose; and
one or more Volatile Organic Compounds, wherein:
the duplicate beverage composition comprises:
(a) between 0.01 and 0.10 percent of weight of Malic Acid based on a total weight percentage of the duplicate beverage composition;
(b) between 0.05 and 1.0 percent of weight of Citric Acid based on a total weight percentage of the duplicate beverage composition; or
(c) between 0.0005 and 1.0 percent of weight of Ascorbic Acid based on a total weight percentage of the duplicate beverage composition;
the duplicate beverage composition is substantially free from natural juice, and
the duplicate beverage composition exhibits a same aroma, taste, mouthfeel, or overall experience, or any combination thereof, of the natural juice.

2. The duplicate beverage composition of claim 1, wherein the duplicate beverage composition comprises between 0.0005 and 1.0 percent of weight of the Volatile Organic Compounds based on a total weight percentage of the beverage composition.

3. The duplicate beverage composition of claim 1, wherein the duplicate beverage composition comprises between 1.0 and 20.0 percent of weight of the Fructose based on a total weight percentage of the duplicate beverage composition.

4. The duplicate beverage composition of claim 1, wherein the duplicate beverage composition further comprises Glycerin, and wherein the duplicate beverage composition comprises between 1.0 and 5.0 percent of weight of the Glycerin based on a total weight percentage of the duplicate beverage composition.

5. The duplicate beverage composition of claim 1, wherein the duplicate beverage composition comprises between 70.0 and 98.0 percent of weight of Water based on a total weight percentage of the duplicate beverage composition.

6. A duplicate beverage composition comprising:
300 mL to 500 mL of water;
at least one of Malic Acid, Citric Acid, or Ascorbic Acid;
Fructose; and
one or more Volatile Organic Compounds, wherein:
the duplicate beverage composition is substantially free from natural juice, and
the duplicate beverage composition exhibits a same aroma, taste, mouthfeel, or overall experience, or any combination thereof, of the natural juice.

7. The duplicate beverage composition of claim 6, further comprising around 0.25 grams of malic acid.

8. The duplicate beverage composition of claim 6, further comprising around 2.5 grams of citric acid.

9. The duplicate beverage composition of claim 6, further comprising around 0.1 grams of ascorbic acid.

10. The duplicate beverage composition of claim 6, wherein the one or more volatile organic compounds form a flavor base for the duplicate beverage composition.

11. A method for making a duplicate beverage composition, comprising:
adding an amount of water to a mixing vessel;
adding and an amount of malic acid to the mixing vessel and mixing the malic acid with the water,
adding an amount of citric acid to the mixing vessel and mixing the citric acid with the water and/or the malic acid;
adding an amount of ascorbic acid to the mixing vessel and mixing the ascorbic acid with the water, the citric acid, and/or the malic acid;
adding an among of fructose to the mixing vessel and mixing the fructose with the water, the citric acid, the malic acid, and/or the ascorbic acid;
adding an amount of glycerin to the mixing vessel and mixing the glycerin with the water, the citric acid, the malic acid, the ascorbic acid, and/or the fructose;
adding one or more volatile organic compounds to the mixing vessel and mixing the one or more volatile organic compounds with the water, the citric acid, the malic acid, the ascorbic acid, the fructose, and/or the glycerin; and
adding natural coloring material to the mixing vessel and mixing the natural coloring material with the water, the citric acid, the malic acid, the ascorbic acid, the fructose, the glycerin, and/or the one or more volatile organic compounds.

12. The method of claim 11, wherein the amount of malic acid is around 0.25 grams of malic acid.

13. The method of claim 11, wherein the amount of citric acid is around 2.5 grams of citric acid.

14. The method of claim 11, wherein the amount of ascorbic acid is around 0.1 grams of ascorbic acid.

15. The method of claim 11, wherein the amount of fructose is around 50 grams of fructose.

16. The method of claim 11, wherein the amount of glycerin is around 12.5 grams of glycerin.

17. The method of claim 11, wherein the water, the citric acid, the malic acid, the ascorbic acid, the fructose, the glycerin, the one or more volatile organic compounds, and the natural coloring material are added to the mixing vessel in no particular order.

18. The method of claim 11, wherein the water, the citric acid, the malic acid, the ascorbic acid, the fructose, the glycerin, the one or more volatile organic compounds, and the natural coloring material are added to the mixing vessel in a particular order.

19. The method of claim 11, wherein the one or more volatile organic compounds are selected from a group consisting of Acetone, Ethyl Acetate, Butanoic acid, 2-methyl-, ethyl ester, Camphene, Myrcene, Pinene, Phellandrene, Pinene, Terpinene, Limonene, Terpinene, Terpinolene, Linalool, Citral, and Geraniol.

20. The method of claim 11, wherein a total mass per liter of the one or more organic volatile compounds is between 200 milligrams/liter and 230 milligrams/liter of a total amount of the beverage.
